(19) United States
(12) Patent Application Publication
(10) Pub. No.: US 2004/0075735 A1
(43) Pub. Date: Apr. 22, 2004

(54) Method and system for producing a pseudo three-dimensional display utilizing a two-dimensional display device

(75) Inventor: George Marmaropoulos, Yorktown Heights, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V.

(21) Appl. No.: 10/273,101

(22) Filed: Oct. 17, 2002

(51) Int. Cl. H04N 15/00

(52) U.S. Cl. 348/51

(57) ABSTRACT

A method is directed to producing a pseudo three-dimensional display for a display device. The method provides for sensing a user position and determining positioning information for at least one object displayed on the display device. The method further provides for determining display data for the at least one object based on the user position and the positioning information. The method additionally provides for displaying the at least one object utilizing the display device based on the determined display data. The method of sensing the user position may provide for identifying a user utilizing a sensor device and determining the user position relative to the sensor. The user position may include multi-dimensional vector data identifying at least one viewing angle of a user relative to the display device. The positioning information may include a multi-coordinate location and a depth location for each object within the object database.

### FIELD OF THE INVENTION

In general, the invention relates to the field of computer graphics, including graphical user interfaces. More specifically, the invention relates to a method and system for producing a pseudo three-dimensional display utilizing a two-dimensional display device.

### BACKGROUND OF THE INVENTION

Current three-dimensional (3D) graphic systems utilizing two-dimensional (2D) raster displays typically achieve realistic 3D effects by rendering objects on the 2D graphics raster display using perspective algorithms. One such perspective algorithm is a “z-divide” algorithm. The “z-divide” algorithm provides for identifying a three-dimensional coordinate for each location point of every object, comparing the three-dimensional coordinates of the object, and determining which location point will be displayed based on the comparison.

Another method of producing a 3D effect includes rendering objects on the 2D display utilizing parallel projection. Parallel projection provides for identifying the depth of each object and “covering up” the portions of objects located behind other objects.

Unfortunately, while the perspective algorithm methods provide realistic 3D graphics, there is a tremendous computing requirement. Additionally, utilizing parallel projection methods results in less than desirable 3D effects as user location and movement resulting in parallax are not included.

It would be desirable, therefore, to provide a method and system that would overcome these and other disadvantages.

### SUMMARY OF THE INVENTION

The present invention relates to the field of computer graphics, including graphical user interfaces, and more particularly to producing a pseudo three-dimensional display utilizing a two-dimensional display device. The present invention allows a graphic system to sense a user position, determine positioning information of one or more objects in the graphic display, determine updated display data for the objects, and display the objects.

One aspect of the invention provides a method for producing a pseudo three-dimensional display for a display device by sensing a user position and determining positioning information for at least one object displayed on the display device. The method further provides for determining display data for the at least one object based on the user position and the positioning information and displaying the at least one object utilizing the display device based on the determined display data.

In accordance with another aspect of the invention, a computer readable medium storing a computer program includes: computer readable code for sensing a user position, computer readable code for determining positioning information for at least one object displayed on the display device, computer readable code for determining display data for the at least one object based on the user position and the positioning information, and computer readable code for displaying the at least one object utilizing the display device based on the determined display data.

In accordance with yet another aspect of the invention, a system for producing a pseudo three-dimensional display for a display device is provided. The system includes means for sensing a user position. The system further includes means for determining positioning information for at least one object displayed on the display device. Means for determining display data for the at least one object based on the user position and the positioning information is provided. Means for displaying the at least one object utilizing the display device based on the determined display data is also provided.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a block diagram illustrating an operating environment according to an embodiment of the present invention;

FIG. 2a is a diagram illustrating an example of a user starting position and relative display in accordance with the present invention;

FIG. 2b is a diagram illustrating an example of a user finishing position and relative display in accordance with the present invention; and

FIG. 3 is a flow diagram depicting an exemplary embodiment of code on a computer readable medium in accordance with the present invention.

### DETAILED DESCRIPTION OF THE PRESENTLY PREFERRED EMBODIMENT

Throughout the specification, and in the claims, the term “connected” means a direct electrical connection between the things that are connected, without any intermediate devices. The term “coupled” means either a direct electrical connection between the things that are connected or an indirect connection through one or more passive or active intermediary devices.

Illustrative Operating Environment

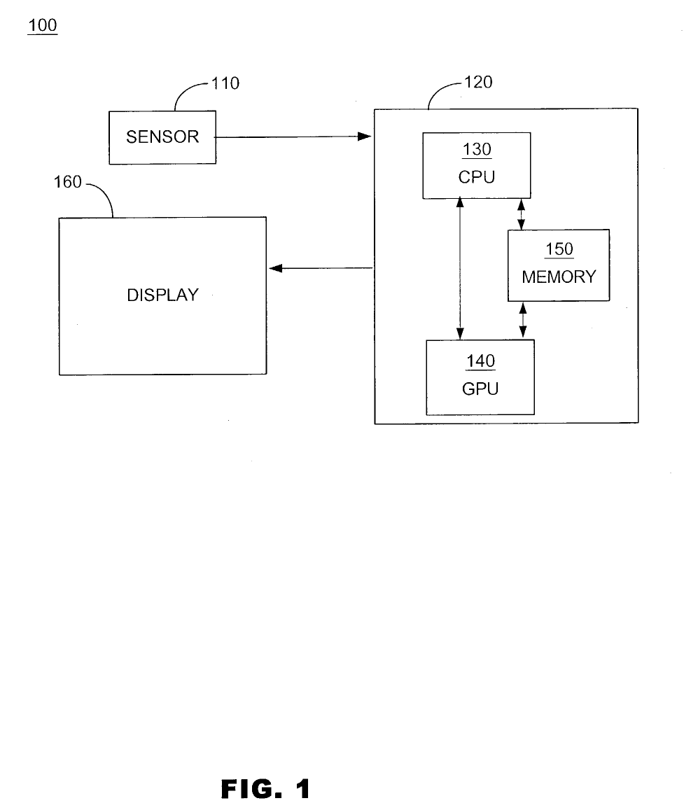

FIG. 1 is a block diagram illustrating an example of an operating environment that is in accordance with the present invention. FIG. 1 details an embodiment of a system for producing a pseudo three-dimensional (3D) display for a display device, in accordance with the present invention, and may be referred to as a pseudo three-dimensional (3D) display system 100. The pseudo three-dimensional (3D) display system 100 includes a sensing device 110, a computer system 120, and a display device 160. The computer system 120 further includes a central processing unit (CPU) 130, a graphics processing unit (GPU) 140, and memory 150.

In FIG. 1 sensing device 110 is coupled to central processing unit (CPU) 130 via computer system 120. Display device 160 is coupled to GPU 140 via computer system 120. Within computer system 120, CPU 130 is coupled to GPU 140 and memory 150. Memory 150 is additionally coupled to GPU 140.

Sensing device 110 is an input device that locates a user position and provides user location information to the computer graphics system 120. In one embodiment, sensing device 110 is implemented as a thermal sensor device. In another embodiment, sensing device 110 is implemented as a motion sensor device. In an example, the motion sensor device is implemented as a video motion sensing device.

In yet another embodiment, sensing device 110 is implemented as a radio frequency sensor device. In another embodiment, a sensing device 110 is implemented as computer vision based system utilizing image processing techniques in determining user position.

Computer system 120 is a computing device that receives user input data from sensing device 110, processes the received user input data, and passes the processed data to display device 160. In one embodiment, computer system 120 is implemented as a personal computer (PC). In another embodiment, computer system 120 is implemented as a work station.

CPU 130 is a processing device within computer system 120 that provides the processing within computer system 120. In one embodiment, CPU 130 receives user input data from sensing device 110 as well as object data from memory 150 for each object displayed in the display device. In this embodiment, CPU 130 processes the received object data into positioning data, also referred to as positioning information, and passes the positioning data to the GPU 140. In one example, the CPU is implemented as a conventional CPU and the GPU is implemented as a video card, as is known in the art.

In another embodiment, CPU 130 receives the user input data and the object data and passes the data to GPU 140 for processing. In this embodiment, GPU 140 processes the received data into positioning data.

GPU 140 is a display device controller that receives data from CPU 130 and memory 150, and processes the received data into display data for each object displayed in the display device. GPU 140 includes a processor, video memory, a frame buffer control, a display adapter controller, and the like. In one embodiment, GPU 140 receives positioning data from CPU 130 and additional object data from memory 150, and processes the received data into display data.

In another embodiment, GPU 140 receives user input data and object data from CPU 130 and processes the received data into positioning data. In this embodiment, GPU 140 receives additional object data from memory 150 and processes the received object data and the processed positioning data into display data.

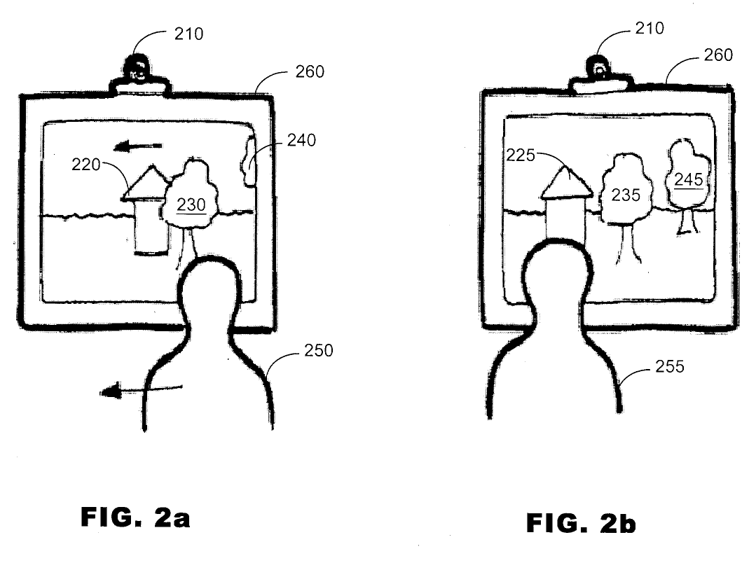

Memory 150 is a memory storage medium capable of receiving, storing, and passing data to CPU 130 and GPU 140. In one embodiment, memory 150 includes an object database having data associated with each object within the object database. In an example, the object database of memory 150 includes data associated with objects 220-245 detailed in FIGS. 2a and 2b, below.

In another embodiment, memory 150 additionally includes program data providing additional objects requiring CPU 130 processing. Memory 150 may be implemented as any memory device suitable for information storage, such as random access memory (RAM), read only memory (ROM), and the like.

Display device 160 is a two-dimensional (2D) raster display that receives display data from GPU 140 and displays the object based on the received data. In one embodiment, display device 160 is implemented as a cathode ray tube (CRT) monitor. In another embodiment, display device 160 is implemented as a flat panel display. In an example, display device 160 is implemented as a TFT display. In another example, display device 160 is implemented as a liquid crystal display (LCD) display.

FIG. 2a is a diagram illustrating an example of a user starting position and relative display in accordance with the present invention. FIG. 2a includes a sensing device 210, first object 220, second object 230, third object 240, exemplary user 250, and display device 260.

Sensing device 210 is an input device that locates a user position and provides user location information to a computer graphics system (not shown). Sensing device 210 of FIG. 2a functions similarly to sensing device 110 of FIG. 1, above.

Objects 220-240 are software components with each object having a plurality of polygons defining it. Objects 220-240 represent a first position based on an exemplary user starting location. Exemplary user 250 represents a user starting location for purposes of describing the present invention.

Display device 260 is a two-dimensional (2D) raster display that receives display data from a computer graphics system (not shown) and displays objects based on the received data. Display device 260 of FIG. 2a functions similarly to display device 160 of FIG. 1, above.

FIG. 2b is a diagram illustrating an example of a user finishing position and relative display in accordance with the present invention. FIG. 2b includes a sensing device 210, first object 225, second object 235, third object 245, exemplary user 255, and display device 260. Like numbered components are numbered and function identically.

Objects 225-245 are software components with each object having a plurality of polygons defining it. Objects 225-245 represent a second position of objects 220-240 based on an exemplary user finishing location. That is, each object in FIG. 2a has a corresponding object in FIG. 2b. Exemplary user 255 represents a user finishing location for purposes of describing the present invention.

In operation and referring to FIGS. 1, 2a and 2b above, sensing device 210 of FIG. 2a locates an exemplary user 250 starting location and provides user location information to the computer graphics system 120. Objects 220-240 are displayed via GPU 140 in display device 260 with corresponding positioning data and display data stored in memory 150.

Sensing device 210 of FIG. 2b locates an exemplary user 255 finishing location and provides user location information to the computer graphics system 120. Objects 225-245 are displayed via GPU 140 in display device 260 with corresponding positioning data and display data stored in memory 150.

Objects 220-240 are displayed via GPU 140 in a layered format. Each object includes a plurality of polygons in addition to other information defining it. Each object additionally includes a layer identifier for determining a depth location within a layered display format. That is, based on positioning information, each object is assigned a depth location within the layered display format.

When more than one object occupies the same location, the object with the depth location closer to the user is utilized. When objects partially overlap, the overlapping polygons are compared to determine portions of an object that will be rendered resulting in one object appearing to be closer than another object.

By providing a dynamic point of reference, the system provides a more visually esthetic three-dimensional (3D) rendering utilizing the two-dimensional (2D) raster display device. That is, when the system receives user positioning information the system is able to recalculate the display data based on tnsor. In another embodiment, the user position includes multi-dimensional vector data identifying at least one viewing angle of a user relative to the display device. Method 300 then advances to block 330.

At block 330, positioning information for at least one object displayed on the display device is determined. In one embodiment, positioning information for at least one object displayed on the display device is determined utilizing CPU 120 of FIG. 1, above. In another embodiment, positioning information includes a multi-coordinate location and a depth location for each object within the object database. Method 300 then advances to block 340.

At block 340, display data for the at least one object based on the user position and the positioning information is determined. In one embodiment, determining display data for the at least one object includes determining a user viewing angle based on the sensed user position, determining a location for the at least one object displayed in the display device based on the positioning information, and determining a display location for the at least one object based on the determined user viewing angle and the determined location for the at least one object.

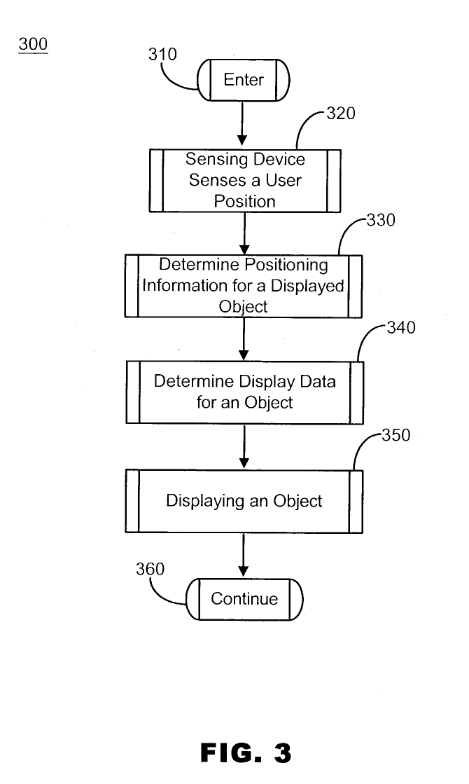

FIG.3 is a flow diagram depicting an exemplary embodiment of code on a computer readable medium in accordance with the present invention. FIG. 3 detailes an embodiment of a method 300 for producing a pseudo three-dimensional display utilizing a two-dimensional display device. Method 300 may utilize one or more systems detailed in FIG. 1 above. Method 300 may also utilize elements detailed in FIGS. 2a and 2b above.

Method 300 begins at block 310 where a central processing unit determins a user has changed locations or the layered display format within the display device requires updating. Method 300 then advances to block 320.

At block 320, the sensing device senses the position of the user. In one embodiment, sensing the position of the user includes identifying the user utilizing the sensor device and determining the user position releative to the sensor. In another embodiment, the user position includes multi-dimensional vector data identifying at least one viewing angle of a user relative to the display device. Method 300 then advances to block 330.

At block 330, positioning information for at least one object displayed on the display device is determined. In one embodiment, positioning information for at least one object displayed on the display device is determined utilizing CPU 120 of FIG. 1, above. In another embodiment, positioning information includes a multi-coordinate location and a depth location for each object within the object database. Method 300 then advances to block 340.

At block 340, display data for the at least one object based on the user position and the positioning information is determined. In one embodiment, determining display data for the at least one object includes determining a user viewing angle based on the sensed user position, determining a location for the at least one object displayed in the display device based on the positioning information, and determining a display location for the at least one object based on the determined user viewing angle and the determined location for the at least one object.

In another embodiment, determining display data for the at least one object further includes assigning a layer value to the at least one object based on the display location, determining a portion of the at least one object for display based on the assigned layer value, determining at least one polygon to be rasterized of the determined portion of the displayed object based on the assigned layer value, determining at least one pixel to be rendered of the rasterized polygon, and rendering the determined pixel. Method 300 then advances to block 350.

At block 350, the at least one object is displayed utilizing the display device based on the determined display data. In one embodiment, the object is displayed utilizing the display device as described in FIGS. 1, 2a, and 2b, above. Method 300 then advances to block 360 where it returns to standard programming.

The above-described methods and implementation for producing a pseudo three-dimensional display utilizing a two-dimensional display device are example methods and implementations. These methods and implementations illustrate one possible approach for producing a pseudo three-dimensional display utilizing a two-dimensional display device. The actual implementation may vary from the method discussed. Moreover, various other improvements and modifications to this invention may occur to those skilled in the art, and those improvements and modifications will fall within the scope of this invention as set forth in the claims below.

The present invention may be embodied in other specific forms without departing from its essential characteristics. The described embodiments are to be considered in all respects only as illustrative and not restrictive.

We claim:

1. A method for producing a pseudo three-dimensional display for a display device, the method comprising:
sensing a user position;
determining positioning information for at least one object displayed on the display device;
determining display data for the at least one object based on the user position and the positioning information; and
displaying the at least one object utilizing the display device based on the determined display data.

2. The method of claim 1 wherein sensing the user position comprises:
identifying a user utilizing a sensor device; and
determining the user position relative to the sensor.

3. The method of claim 2 wherein the sensor device is selected from a group consisting of: a thermal sensor device, a motion sensor device, and a radio frequency sensor device.

4. The method of claim 1 wherein the user position includes multi-dimensional vector data identifying at least one viewing angle of a user relative to the display device.

5. The method of claim 1 wherein the positioning information includes a multi-coordinate location and a depth location for each object within the object database.

6. The method of claim 1 wherein determining the display data comprises:
determining a user viewing angle based on the sensed user position;
determining a location for the at least one object displayed in the display device based on the positioning information; and
determining a display location for the at least one object based on the determined user viewing angle and the determined location for the at least one object.

7. The method of claim 6 wherein determining display data for the at least one object further comprises:
assigning a layer value to the at least one object based on the display location;
determining a portion of the at least one object for display based on the assigned layer value;
determining at least one polygon to be rasterized of the determined portion of the displayed object based on the assigned layer value;
determining at least one pixel to be rendered of the rasterized polygon; and
rendering the determined pixel.

8. A computer readable medium storing a computer program comprising:
computer readable code for sensing a user position;
computer readable code for determining positioning information for at least one object displayed on the display device;
computer readable code for determining display data for the at least one object based on the user position and the positioning information; and
computer readable code for displaying the at least one object utilizing the display device based on the determined display data.

9. The computer readable medium of claim 8 wherein sensing the user position comprises:
computer readable code for identifying a user utilizing a sensor device; and
computer readable code for determining the user position relative to the sensor.

10. The computer readable medium of claim 8 wherein the sensor device is selected from a group consisting of: a thermal sensor device, a motion sensor device, and a radio frequency sensor device.

11. The computer readable medium of claim 8 wherein the user position includes multi-dimensional vector data identifying at least one viewing angle of a user relative to the display device.

12. The computer readable medium of claim 8 wherein the positioning information includes a multi-coordinate location and a depth location for each object within the object database.

13. The computer readable medium of claim 8 wherein determining the display data comprises:
computer readable code for determining a user viewing angle based on the sensed user position;
computer readable code for determining a location for the at least one object displayed on the display device based on the positioning information;
computer readable code for determining a display location for the at least one object based on the determined user viewing angle and the determined location for the at least one object.

14. The computer readable medium of claim 13 wherein determining display data for the at least one object further comprises:
computer readable code for assigning a layer value to the at least one object based on the display location;
computer readable code for determining a portion of the at least one object for display based on the assigned layer value;
computer readable code for determining at least one polygon to be rasterized of the determined portion of the displayed object based on the assigned layer value;
computer readable code for determining at least one pixel to be rendered of the rasterized polygon; and
computer readable code for rendering the determined pixel.

15. A system for producing a pseudo three-dimensional display for a display device comprising:
means for sensing a user position:
means for determining positioning information for at least one object displayed on the display device;
means for determining display data for the at least one object based on the user position and the positioning information; and
means for displaying the at least one object utilizing the display device based on the determined display data.
